(19) United States
(12) Patent Application Publication
(10) Pub. No.: US 2026/0046871 A1
(43) Pub. Date: Feb. 12, 2026

(54) ENHANCEMENT OF UPLINK PROCEDURES FOR RANDOM ACCESS

(71) Applicant: QUALCOMM Incorporated, San Diego, CA (US)

(72) Inventors: Jing LEI, San Diego, CA (US); Jing SUN, San Diego, CA (US); Linhai HE, San Diego, CA (US)

(21) Appl. No.: 18/797,203

(22) Filed: Aug. 7, 2024

(51) Int. Cl. H04W 72/21; H04W 74/0833

(52) U.S. Cl. CPC H04W 72/21; H04W 74/0833

(57) ABSTRACT

The apparatus may be a wireless device configured to receive, in a message of a random access procedure, an indication of an UL grant for a subsequent PUSCH transmission, refrain from transmitting an acknowledgement relating to the UL grant and the message of the random access procedure, and transmit, based on a successful decoding of the UL grant, the subsequent PUSCH transmission. In some examples, the apparatus may be a network device configured to transmit, in a message of a random access procedure, an indication of an UL grant for a subsequent PUSCH transmission, and receiving the subsequent PUSCH transmission in a set of resources identified in the UL grant.

### TECHNICAL FIELD

The present disclosure relates generally to communication systems, and more particularly, to a random access (RA) procedure for wireless communication.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device such as a user equipment (UE) or component thereof configured to receive, in a message of a random access procedure, an indication of an uplink (UL) grant for a subsequent physical UL shared channel (PUSCH) transmission, refrain from transmitting an acknowledgement relating to the UL grant and the message of the random access procedure, and transmit, based on a successful decoding of the UL grant, the subsequent PUSCH transmission.

In an aspect of the disclosure, a method, a computer-readable medium, and an apparatus are provided. The apparatus may be a network device such as a base station or component thereof configured to transmit, in a message of a random access procedure, an indication of an UL grant for a subsequent PUSCH transmission, and receiving the subsequent PUSCH transmission in a set of resources identified in the UL grant.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and

an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and UE in an access network.

FIG. 4A is a diagram illustrating aspects of a 4-step CFRA procedure in accordance with some aspects of the disclosure.

FIG. 4B is a diagram illustrating aspects of a 2-step CFRA procedure in accordance with some aspects of the disclosure.

FIG. 5 is a diagram illustrating aspects of a RA procedure in accordance with some aspects of the disclosure.

FIG. 6A is a diagram illustrating a CFRA procedure including an early indication of an UL grant in accordance with some aspects of the disclosure.

FIG. 6B is a diagram illustrating a CFRA procedure including an early indication of an UL grant in accordance with some aspects of the disclosure.

FIG. 7A is a diagram illustrating a CBRA procedure including an early indication of an UL grant in accordance with some aspects of the disclosure.

FIG. 7B is a diagram illustrating a CBRA procedure including an early indication of an UL grant in accordance with some aspects of the disclosure.

FIG. 8 is a diagram illustrating an RA procedure including an early indication of an UL grant in accordance with some aspects of the disclosure.

FIG. 9 is a call flow diagram illustrating a method of wireless communication in accordance with some aspects of the disclosure.

FIG. 10 is a flowchart of a method of wireless communication.

FIG. 11 is a flowchart of a method of wireless communication.

FIG. 12 is a flowchart of a method of wireless communication.

FIG. 13 is a diagram illustrating an example of a hardware implementation for an example apparatus and/or network entity.

FIG. 14 is a diagram illustrating an example of a hardware implementation for an example network entity.

### DETAILED DESCRIPTION

In some aspects of wireless communication, a random access (RA) procedure (alternatively referred to as random access, a random access process, an initial access procedure and/or process, a RACH process and/or procedure) may include an exchange of a set of messages between a wireless device and a base station to which the wireless device is attempting to access. A particular RA procedure, in some aspects, may be associated with a “category” and “type” of RA procedure. For example, the “categories” of RA procedures may include (1) contention-based random access (CBRA) and (2) contention-free random access (CFRA) while the “types” of RA procedures may include (i) a 2-step RA type and (ii) a 4-step RA type (where a particular RA procedure may be associated with any combination of category and type, e.g., a 4-step CFRA procedure). For procedures based on CFRA such as handover (HO), beam failure recovery (BFR), and secondary timing advance group (sTAG) establishment, a network may provide an UL grant for a wireless device (e.g., a UE) to transmit a radio resource control (RRC) message (e.g., RRCReconfigurationComplete or UE assistance information [UAI]) or medium access control (MAC) control element (MAC-CE) (e.g., for a buffer status report [BSR] or a power headroom report [PHR]). The UL grant, in some aspects, may be issued and/or transmitted by the network after the network receives from the wireless device an acknowledgement (ACK) to a RA response (RAR).

Various aspects relate generally to including an UL grant in a set of transmissions associated with a RAR (or contention resolution). Some aspects more specifically relate to a downlink control information (DCI) scheduling a RAR (or contention resolution message) also including an indication of whether the RAR includes an UL grant. If included, the UE may receive the UL grant in the RAR and refrain from transmitting an ACK or a negative ACK (NACK) (A/N) in a physical UL control channel (PUCCH) transmission. In some examples, a wireless device (or UE) may be configured to receive, in a message of a random access procedure, an indication of an UL grant for a subsequent PUSCH transmission, refrain from transmitting an acknowledgement relating to the UL grant and the message of the random access procedure, and transmit, based on a successful decoding of the UL grant, the subsequent PUSCH transmission. In some examples, a network device may be configured to transmit, in a message of a random access procedure, an indication of an UL grant for a subsequent PUSCH transmission, and receiving the subsequent PUSCH transmission in a set of resources identified in the UL grant.

Particular aspects of the subject matter described in this disclosure can be implemented to realize one or more of the following potential advantages. In some examples, by including the UL grant in a set of transmissions associated with a RAR (or contention resolution) or including (in a DCI scheduling a RAR) an indication that the RAR includes an UL grant (and including the UL grant in the RAR), the described techniques can be used to improve the latency and energy efficiency of RA (e.g., CFRA and/or CBRA) procedures, resolve potential ambiguity when including the UL grant in the RAR (or an associated transmission), and provide more flexible UL scheduling for RA procedures.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

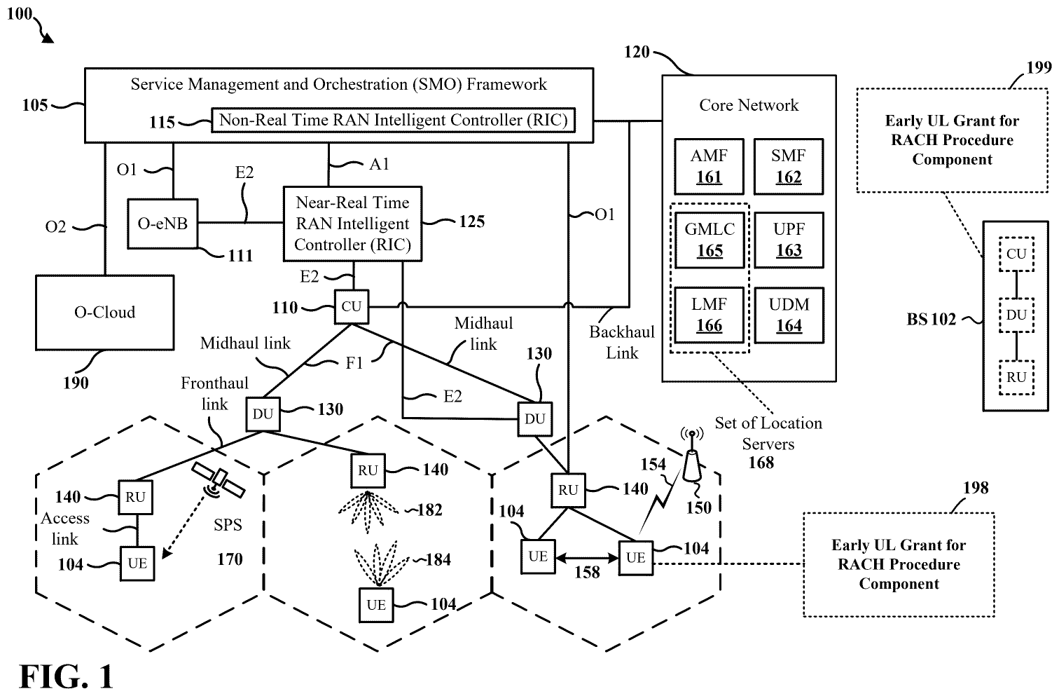

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an early UL grant for RACH procedure component 198 that may be configured to receive, in a message of a random access procedure, an indication of an UL grant for a subsequent PUSCH transmission, refrain from transmitting an acknowledgement relating to the UL grant and the message of the random access procedure, and transmit, based on a successful decoding of the UL grant, the subsequent PUSCH transmission. In certain aspects, the base station 102 may have an early UL grant for RACH procedure component 199 that may be configured to transmit, in a message of a random access procedure, an indication of an UL grant for a subsequent PUSCH transmission, and receiving the subsequent PUSCH transmission in a set of resources identified in the UL grant. Although the following description may be focused on 5G NR, the concepts described herein may be applicable to other similar areas, such as LTE, LTE-A, CDMA, GSM, and other wireless technologies.

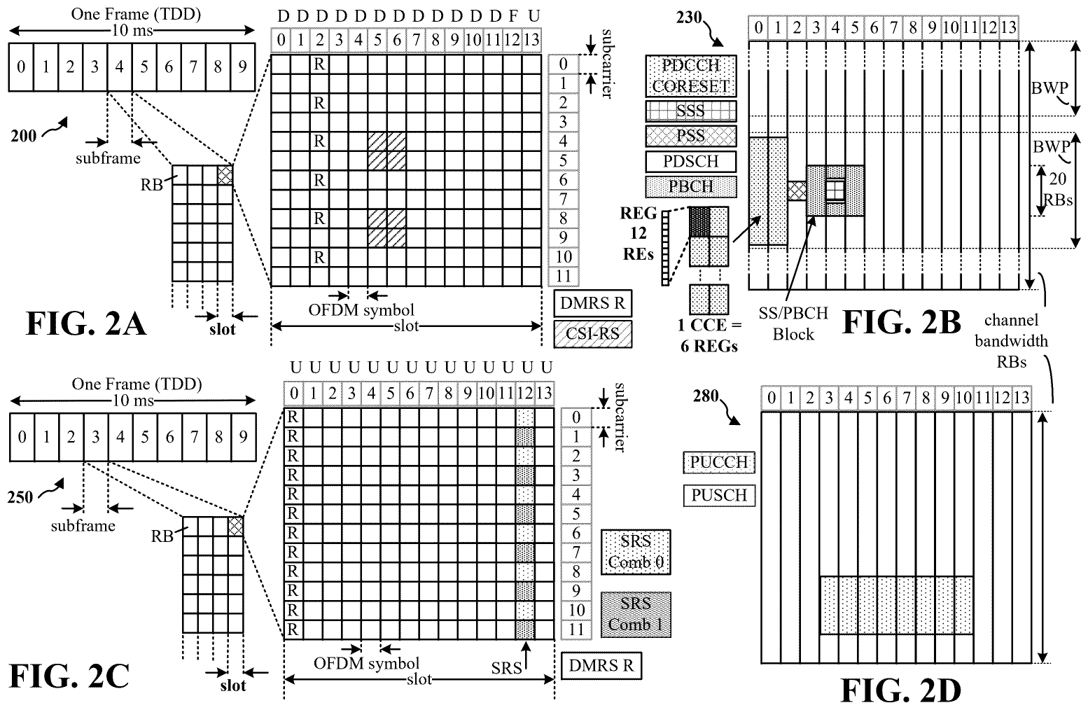

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

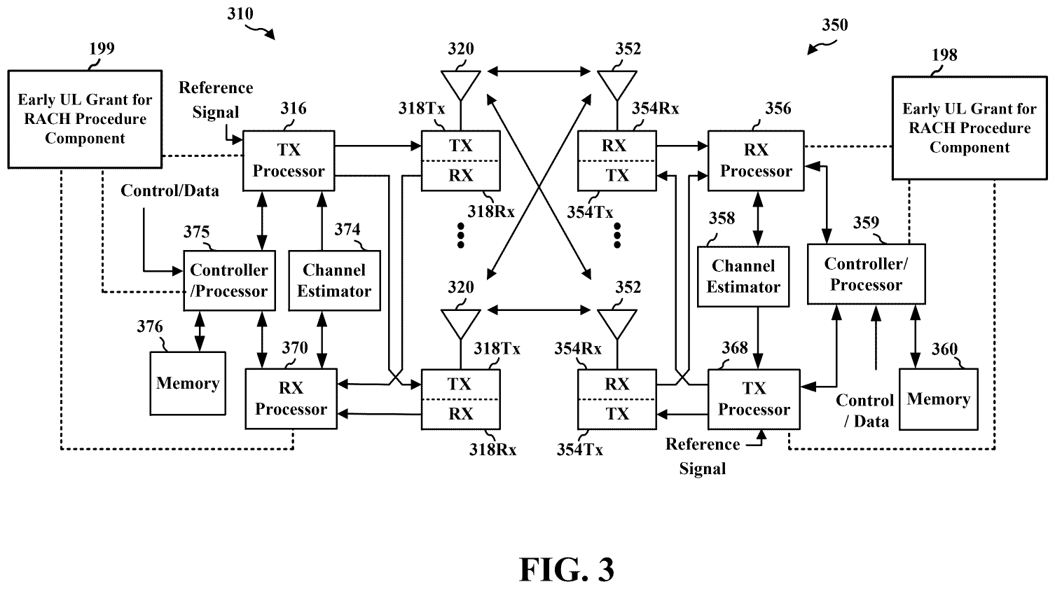

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the early UL grant for RACH procedure component 198 of FIG. 1.

At least one of the TX processor 316, the RX processor 370, and the controller/processor 375 may be configured to perform aspects in connection with the early UL grant for RACH procedure component 199 of FIG. 1.

In some aspects of wireless communication, a RA procedure (alternatively referred to as random access, a random access process, an initial access procedure and/or process, a RACH process and/or procedure) may be associated with a set of messages exchanged between a wireless device and a base station to which the wireless device is attempting to access. For example, the UE may use the random access procedure to request an RRC connection, to re-establish an RRC connection, resume an RRC connection, etc. A UE may use a random access procedure in order to communicate with a base station. A particular RA procedure, in some aspects, may be associated with a “category” and “type” of RA procedure. For example, the “categories” of RA procedures may include (1) CBRA and (2) CFRA while the “types” of RA procedures may include (i) a 2-step RA type and (ii) a 4-step RA type (where a particular RA procedure may be associated with any combination of category and type, e.g., a 4-step CFRA procedure). The UE may use Contention Based Random Access (CBRA) that may be performed when a UE is not synchronized with a base station, and the CFRA may be applied, e.g., when the UE was previously synchronized to a base station. Both the procedures include transmission of a random access preamble from the UE to the base station. In CBRA, a UE may randomly select a random access preamble sequence, e.g., from a set of preamble sequences. As the UE randomly selects the preamble sequence, the base station may receive another preamble from a different UE at the same time. Thus, CBRA provides for the base station to resolve such contention among multiple UEs. In CFRA, the network may allocate a preamble sequence to the UE rather than the UE randomly selecting a preamble sequence. This may help to avoid potential collisions with a preamble from another UE using the same sequence. Thus, CFRA is referred to as “contention free” random access.

For procedures based on CFRA such as HO, BFR, and sTAG establishment, a network may provide an UL grant for a wireless device (e.g., a UE) to transmit an RRC message (e.g., RRCReconfigurationComplete or UAI) or MAC-CE (e.g., for a BSR or a PHR). The UL grant, in some aspects, may be issued and/or transmitted by the network after the network receives from the wireless device an ACK to a RAR.

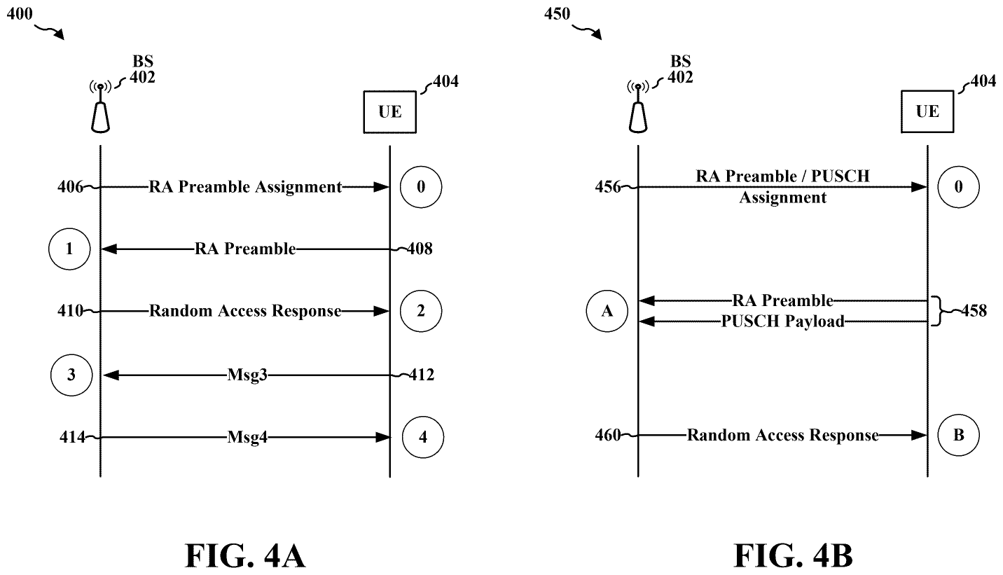

FIG. 4A is a diagram 400 illustrating aspects of a 4-step CFRA procedure in accordance with some aspects of the disclosure. A base station 402 may transmit, and a UE 404 may receive, an RA preamble assignment 406 (e.g., initial configuration information) indicating one or more of the content of at least a first message of an associated RA procedure and/or resources associated with at least the first message of the associated RA procedure. In some aspects, the UE 404 may receive random access parameters (e.g., preamble information, preamble format parameters, time and frequency resources, parameters for determining root sequences and/or cyclic shifts for a random access preamble) in system information and/or a random access configuration.

Based on the initial configuration information, the UE 404 may transmit, and the base station 402 may receive, a first message 408 (e.g., a Msg1 of the 4-step RA procedure) including a preamble, and via PRACH resources (e.g., a random access occasion (RO)), based on, or indicated in, the RA preamble assignment 406. In response to the first message 408, the base station 402 may transmit, and the UE 404 may receive, a second message 410 (e.g., a Msg2, or RAR, of the 4-step RA procedure). In some aspects, the Msg2 may include a PDSCH transmission. For CFRA, the second message 410 (e.g., the RAR) may carry at least the timing advance (TA) command for a subsequent UL transmission. To complete the CFRA procedure, the UE 404 may transmit an ACK (not shown) on UL resources (PUCCH) indicated in PDCCH scheduling the second message 410 (e.g., the RAR). Upon receiving the RAR, the UE 404 may transmit a third random access message 412 (e.g., Msg3) to the base station 402, e.g., using PUSCH, that may include a RRC connection request, an RRC connection re-establishment request, or an RRC connection resume request, depending on the trigger for the initiating the random access procedure. The base station 402 may then complete the random access procedure by sending a fourth random access message 414 (e.g., Msg4) to the UE 404, e.g., using PDCCH for scheduling and PDSCH for the message. The UE 404 may monitor for PDCCH, e.g., with the C-RNTI. If the PDCCH is successfully decoded, the UE 404 may also decode PDSCH. The UE 404 may send HARQ feedback for any data carried in the fourth random access message.

FIG. 4B is a diagram 450 illustrating aspects of a 2-step CFRA procedure in accordance with some aspects of the disclosure. Aspects of Msg 1 and Msg 3 may be combined in a single message, e.g., which may be referred to as Msg A. The Msg A may include a random access preamble, and may also include a PUSCH transmission, e.g., such as data. FIG. 4B illustrates that a base station 402 may transmit, and a UE 404 may receive, an RA preamble assignment and PUSCH assignment 456 (e.g., initial configuration information) indicating one or more of the content of at least a first message of an associated RA procedure and/or resources associated with at least the first message of the associated RA procedure.

Based on the initial configuration information, the UE 404 may transmit, and the base station 402 may receive, a first message 458 (e.g., a MsgA of the 2-step RA procedure) including a preamble (via PRACH resources) and a PUSCH transmission (e.g., in a PUSCH occasion (PO)), based on, or indicated in, the RA preamble assignment and PUSCH assignment 456. In response to the first message 458, the base station 402 may transmit, and the UE 404 may receive, a second message 460 (e.g., a MsgB, or RAR, of the 2-step RA procedure). For CFRA, the second message 460 (e.g., the RAR) may carry at least the TA command for a subsequent UL transmission. To complete the CFRA procedure, the UE 404 may transmit an ACK (not shown) on UL resources (PUCCH) indicated in PDCCH scheduling the second message 460 (e.g., the RAR).

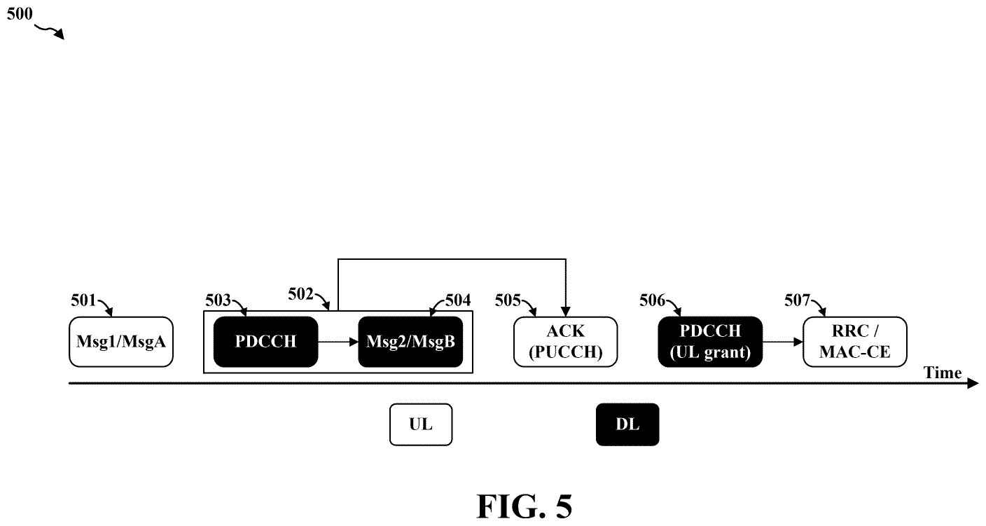

FIG. 5 is a diagram 500 illustrating aspects of a RA procedure in accordance with some aspects of the disclosure. Diagram 500 illustrates that a first message 501 (e.g., Msg1 or MsgA) may be transmitted by a UE and that a subsequent set of messages 502 may be sent in response to the first message 501. The set of messages 502, in some aspects, may include a PDCCH transmission 503 (e.g., DCI) scheduling (1) a RAR (e.g., Msg2/MsgB 504) included in the set of messages 502 and (2) a feedback resource (e.g., PUCCH) for providing an ACK 505 (or NACK) related to the RAR (e.g., Msg2/MsgB 504). If, for a CFRA procedure, the base station receives the ACK 505, the base station may transmit an UL grant 506 (e.g., via a PDCCH transmission) scheduling resources for an additional message 507 (e.g., an RRC message or a MAC-CE). In some latency-sensitive aspects of wireless communication, there may be a benefit to reducing and/or avoiding the latency associated with waiting for an ACK before transmitting an UL grant for an additional message.

Various aspects relate generally to including an UL grant in a set of transmissions associated with a RAR (or contention resolution). Some aspects more specifically relate to a DCI scheduling a RAR (or contention resolution message) also including an indication of whether the RAR includes an UL grant. If included, the UE may receive the UL grant in the RAR and refrain from transmitting an ACK/NACK. In some aspects, the DCI scheduling the RAR may also include the UL grant and/or an additional DCI including the UL grant may be included in the set of transmissions associated with the RAR (or contention resolution). In some examples, a wireless device (or UE) may be configured to receive, in a message of a random access procedure, an indication of an UL grant for a subsequent PUSCH transmission, refrain from transmitting an acknowledgement relating to the UL grant and the message of the random access procedure, and transmit, based on a successful decoding of the UL grant, the subsequent PUSCH transmission. In some examples, a network device may be configured to transmit, in a message of a random access procedure, an indication of an UL grant for a subsequent PUSCH transmission, and receiving the subsequent PUSCH transmission in a set of resources identified in the UL grant.

In some aspects, the disclosure addresses issues raised by including the UL grant in the RAR (or in messages transmitted in association with the RAR). For example, the disclosure addresses whether the UE will transmit an explicit ACK to the RAR, how the UE will handle transmit power control (TPC) received in DCI and TPC in the UL grant, and a timeline for transmitting the RRC message or MAC-CE associated with the UL grant.

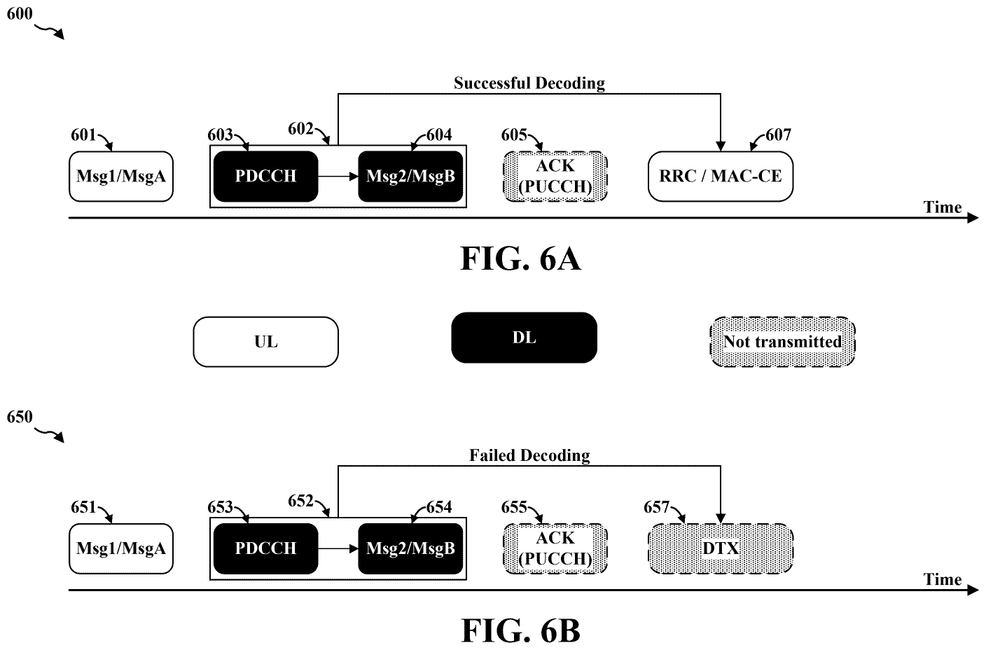

FIG. 6A is a diagram 600 illustrating a CFRA procedure including an early indication of an UL grant in accordance with some aspects of the disclosure. Diagram 600 illustrates that a UE may transmit a first message 601 (e.g., Msg1 or MsgA) and monitor for a PDCCH transmission 603 in a subsequent set of messages 602 that may be sent in response to the first message 601. The set of messages 602, in some aspects, may include the PDCCH transmission 603 (e.g., DCI) scheduling a RAR 604 (e.g., Msg2 or MsgB) included in the set of messages 602 and indicating (e.g., including an indication) that the RAR 604 includes an UL grant for transmitting a follow-up message 607 (e.g., an RRC message and/or MAC-CE). In some aspects, the indication that the RAR 604 includes the UL grant may be a “flag” associated with one of a DCI field, a cyclic redundancy check (CRC) attached to the DCI, a time and/or frequency offset of the PDCCH monitoring occasions, a DM-RS sequence of the PDCCH, or the interleaving and/or scrambling schemes associated with a DM-RS and/or PDCCH associated with the DCI. The DCI, in some aspects, may include new fields to indicate one or more of repetitions, frequency hopping, and/or waveform switching for the RAR 604. In some aspects, the PDCCH transmission 603 may include the UL grant in a same DCI scheduling the RAR 604. The PDCCH transmission 603 or an additional PDCCH transmission associated with the RAR 604, in some aspects, may include an additional DCI including the UL grant.

If the UE receives the PDCCH transmission 603 indicating the inclusion of the UL grant in the RAR 604, the UE may not be expected to transmit the ACK/NACK 605 (e.g., via PUCCH resources associated with the RAR). In some aspects, the DCI field associated with a “PUCCH resource indicator” may be re-purposed (e.g., to indicate the absence/presence of UL grant in RAR) or ignored by the UE (if the inclusion of the UL grant in the RAR is indicated in another way) such that no PUCCH resource is indicated in the DCI scheduling the RAR. If the UE successfully decodes the RAR 604 including the UL grant (or successfully decodes the RAR 604 and an UL grant included in a related DCI), the UE may transmit the follow-up message 607 (e.g., an RRC message and/or MAC-CE via a PUSCH transmission) based on the UL grant, included in, or associated with, the RAR 604. The transmission of the follow-up message 607, in some aspects, may serve as an implicit ACK to the RAR 604.

FIG. 6B is a diagram 650 illustrating a CFRA procedure including an early indication of an UL grant in accordance with some aspects of the disclosure. Diagram 650 mirrors diagram 600 through the transmission of the RAR 654. Accordingly, diagram 650 illustrates that a UE may transmit a first message 651 (e.g., Msg1 or MsgA) and monitor for a PDCCH transmission 653 in a subsequent set of messages 652 that may be sent in response to the first message 651. The set of messages 652, in some aspects, may include the PDCCH transmission 653 (e.g., DCI) scheduling a RAR 654 (e.g., Msg2 or MsgB) included in the set of messages 652 and indicating (e.g., including an indication) that the RAR 654 includes an UL grant for PUSCH resources 657 for transmitting a follow-up message (e.g., an RRC message and/or MAC-CE). In some aspects, the indication that the RAR 654 includes the UL grant may be a “flag” associated with one of a DCI field, a CRC attached to the DCI, a time and/or frequency offset of the PDCCH monitoring occasions, a DM-RS sequence of the PDCCH, or the interleaving and/or scrambling schemes associated with a DM-RS and/or PDCCH associated with the DCI. The DCI, in some aspects, may include new fields to indicate one or more of repetitions, frequency hopping, and/or waveform switching for the RAR 654. In some aspects, the PDCCH transmission 653 may include the UL grant in a same DCI scheduling the RAR. The PDCCH transmission 653 or an additional PDCCH transmission associated with the RAR 654, in some aspects, may include an additional DCI including the UL grant.

If the UE receives the PDCCH transmission 653 indicating the inclusion of the UL grant in the RAR 654, the UE may not be expected to transmit the ACK/NACK 655 (e.g., via PUCCH resources associated with the RAR). In some aspects, the DCI field associated with a “PUCCH resource indicator” may be re-purposed (e.g., to indicate the absence/presence of UL grant in RAR) or ignored by the UE (if the inclusion of the UL grant in the RAR is indicated in another way) such that no PUCCH resource is indicated in the DCI scheduling the RAR. If the UE fails to decode the RAR 654 including the UL grant (or fails to decodes either the RAR 654 or an UL grant included in a related DCI) and/or if the UL grant is determined to be invalid (e.g., if the resources indicated by the UL grant overlap with DL symbols and/or slots in TDD or a switching gap of half-duplex operation), the UE may refrain from transmitting the ACK/NACK655 and the follow-up message (indicated by a discontinuous transmission (DTX) during the PUSCH resources 657 indicated by the UL grant and/or used to transmit the follow-up message 607 when the UE successfully decodes the RAR and the UL grant). In some aspects, the failure of the UE to transmit the follow-up message during the PUSCH resources 657 associated with the UL grant may serve as an implicit NACK to the RAR 654 (and the UL grant). In some aspects, if the UE receives a PDCCH transmission that indicates that an associated RAR (or other PDCCH associated with the RAR) does not include an UL grant, the UE may follow the procedures described in relation to FIG. 5.

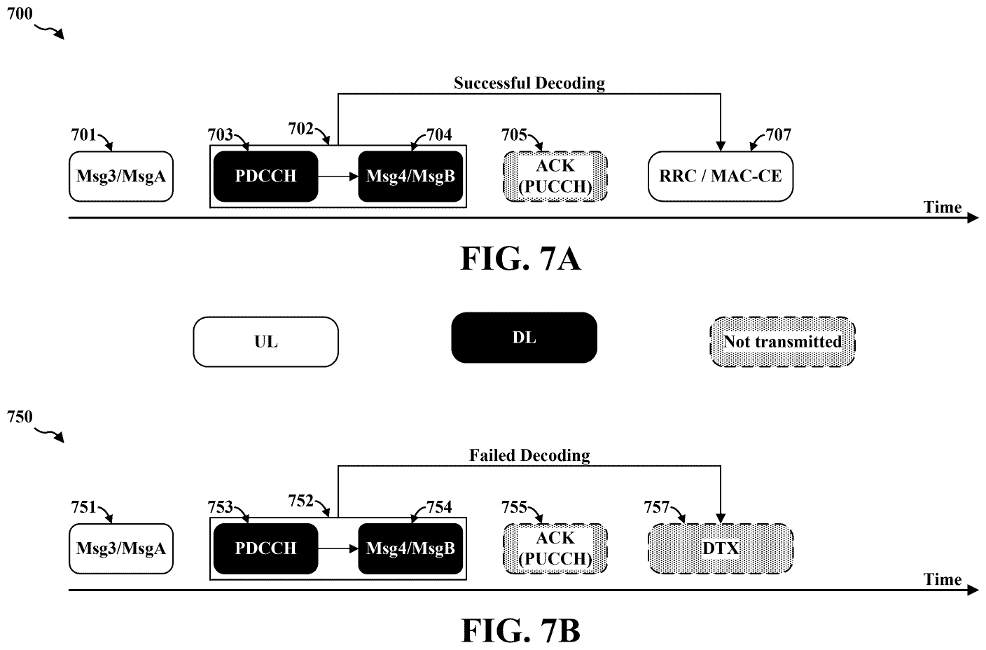

FIG. 7A is a diagram 700 illustrating a CBRA procedure including an early indication of an UL grant in accordance with some aspects of the disclosure. Diagram 700 illustrates that a UE may transmit a first message 701 (e.g., Msg3 or MsgA) and monitor for a PDCCH transmission 703 in a subsequent set of messages 702 that may be sent in response to the first message 701 (where the first message 701 may be a third message in a 4-step CBRA procedure for which the first two messages are not shown). The set of messages 702, in some aspects, may include the PDCCH transmission 703 (e.g., DCI) scheduling a contention resolution message 704 (e.g., Msg4 or MsgB) included in the set of messages 702 and indicating (e.g., including an indication) that the contention resolution message 704 includes an UL grant for transmitting a follow-up message 707 (e.g., an RRC message and/or MAC-CE). In some aspects, the indication that the contention resolution message 704 includes the UL grant may be a “flag” associated with one of a DCI field, a CRC attached to the DCI, a time and/or frequency offset of the PDCCH monitoring occasions, a DM-RS sequence of the PDCCH, or the interleaving and/or scrambling schemes associated with a DM-RS and/or PDCCH associated with the DCI. The DCI, in some aspects, may include new fields to indicate one or more of repetitions, frequency hopping, and/or waveform switching for the contention resolution message 704. In some aspects, the PDCCH transmission 703 may include the UL grant in a same DCI scheduling the contention resolution message 704. The PDCCH transmission 703 or an additional PDCCH transmission associated with the contention resolution message 704, in some aspects, may include an additional DCI including the UL grant.

If the UE receives the PDCCH transmission 703 indicating the inclusion of the UL grant in the contention resolution message 704, the UE may not be expected to transmit the ACK/NACK 705 (e.g., via PUCCH resources associated with the contention resolution message). In some aspects, the DCI field associated with a “PUCCH resource indicator” may be re-purposed (e.g., to indicate the absence/presence of UL grant in contention resolution message) or ignored by the UE (if the inclusion of the UL grant in the contention resolution message is indicated in another way) such that no PUCCH resource is indicated in the DCI scheduling the contention resolution message. If the UE successfully decodes the contention resolution message 704 including the UL grant (or successfully decodes the contention resolution message 704 and an UL grant included in a related DCI), the UE may transmit the follow-up message 707 (e.g., an RRC message and/or MAC-CE via a PUSCH transmission) based on the UL grant, included in, or associated with, the contention resolution message 704. The transmission of the follow-up message 707, in some aspects, may serve as an implicit ACK to the contention resolution message 704.

FIG. 7B is a diagram 750 illustrating a CBRA procedure including an early indication of an UL grant in accordance with some aspects of the disclosure. Diagram 750 mirrors diagram 700 through the transmission of the contention resolution message 754. Accordingly, diagram 750 illustrates that a UE may transmit a first message 751 (e.g., Msg3 or MsgA) and monitor for a PDCCH transmission 753 in a subsequent set of messages 752 that may be sent in response to the first message 751 (where the first message 751 may be a third message in a 4-step CBRA procedure for which the first two messages are not shown). The set of messages 752, in some aspects, may include the PDCCH transmission 753 (e.g., DCI) scheduling a contention resolution message 754 (e.g., Msg4 or MsgB) included in the set of messages 752 and indicating (e.g., including an indication) that the contention resolution message 754 includes an UL grant for PUSCH resources 757 for transmitting a follow-up message (e.g., an RRC message and/or MAC-CE). In some aspects, the indication that the contention resolution message 754 includes the UL grant may be a “flag” associated with one of a DCI field, a CRC attached to the DCI, a time and/or frequency offset of the PDCCH monitoring occasions, a DM-RS sequence of the PDCCH, or the interleaving and/or scrambling schemes associated with a DM-RS and/or PDCCH associated with the DCI. The DCI, in some aspects, may include new fields to indicate one or more of repetitions, frequency hopping, and/or waveform switching for the contention resolution message 754. In some aspects, the PDCCH transmission 753 may include the UL grant in a same DCI scheduling the contention resolution message. The PDCCH transmission 753 or an additional PDCCH transmission associated with the contention resolution message 754, in some aspects, may include an additional DCI including the UL grant.

If the UE receives the PDCCH transmission 753 indicating the inclusion of the UL grant in the contention resolution message 754, the UE may not be expected to transmit the ACK/NACK 755 (e.g., via PUCCH resources associated with the contention resolution message). In some aspects, the DCI field associated with a “PUCCH resource indicator” may be re-purposed (e.g., to indicate the absence/presence of UL grant in contention resolution message) or ignored by the UE (if the inclusion of the UL grant in the contention resolution message is indicated in another way) such that no PUCCH resource is indicated in the DCI scheduling the contention resolution message. If the UE fails to decode the contention resolution message 754 including the UL grant (or fails to decode either the contention resolution message 754 or an UL grant included in a related DCI) and/or if the UL grant is determined to be invalid (e.g., if the resources indicated by the UL grant overlap with DL symbols and/or slots in TDD or a switching gap of half-duplex operation), the UE may refrain from transmitting the ACK/NACK 755 and the follow-up message (indicated by a DTX during the PUSCH resources 757 indicated by the UL grant and/or used to transmit the follow-up message 707 when the UE successfully decodes the contention resolution message and the UL grant). In some aspects, the failure of the UE to transmit the follow-up message during the PUSCH resources 757 associated with the UL grant may serve as an implicit NACK to the contention resolution message 754 (and the UL grant).

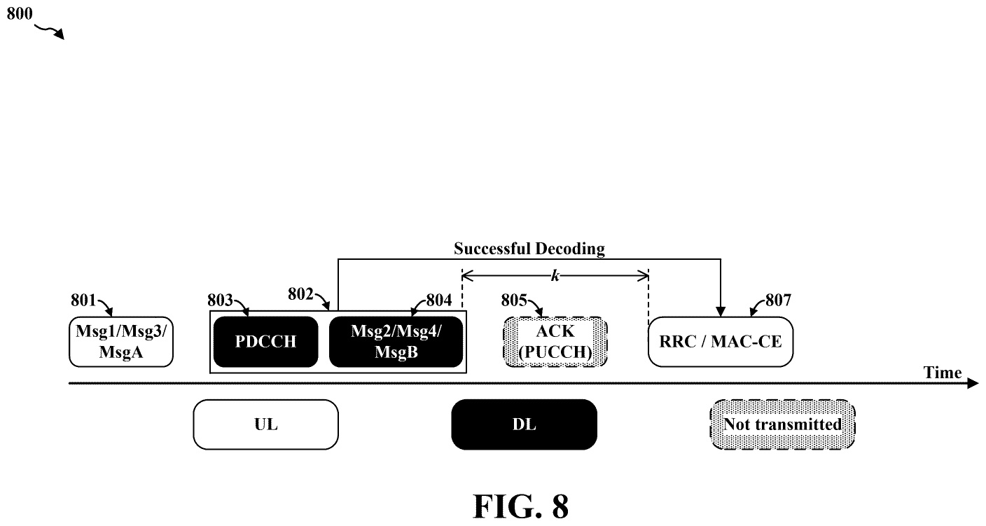

FIG. 8 is a diagram 800 illustrating an RA procedure including an early indication of an UL grant in accordance with some aspects of the disclosure. Diagram 800 illustrates that a UE may transmit a first message 801 (e.g., one of a Msg1 for a 4-step CFRA, a Msg3 for a 4-step CBRA, or a MsgA for either CFRA or CBRA corresponding to one or the first message 601 of FIG. 6A or the first message 701 of FIG. 7A) and monitor for a PDCCH transmission 803 in a subsequent set of messages 802 that may be sent in response to the first message 801. The PDCCH transmission 803, in some aspects, may be configured in any of the ways described above for the PDCCH transmission 603 and/or the PDCCH transmission 703.

If a flag indicating that a message 804 (e.g., one of a Msg2 for a 4-step CFRA, a Msg4 for a 4-step CBRA, or a MsgB for either CFRA or CBRA corresponding to one or the RAR 604 of FIG. 6A or the contention resolution message 704 of FIG. 7A) in the RA procedure includes, or is associated with, the UL grant in the set of messages 802, the UE may also receive an indication of a size of a gap (e.g., k slots, symbols, or ms) between the end (e.g., a last DL slot and/or symbol) of the message 804 (e.g., the Msg2, the Msg4, or the MsgB) and the first slot and/or symbol of the of the follow-up message 807 (e.g., an RRC message or MAC-CE) or the PUSCH resources associated with the UL grant. The indication, in some aspects, may be included in the message 804 (or in a UL grant when the UL grant is transmitted separately from the message 804). The indication of the size of the gap, k, in some aspects, may also be included in any of the CFRA and/or CBRA procedures described in relation to FIGS. 6A, 6B, 7A, and 7B.

In some aspects, the UE may process the PDSCH associated with the message 804 (e.g., the Msg2, the Msg4, or the MsgB), perform TA for CFRA, and prepare for the PUSCH transmission (e.g., the follow-up message 807) during the gap indicated by the value k. In some aspects, the minimum processing time for PDSCH, PUSCH, and TA depends at least on the UE capability, numerology, frequency range, and the type of RA procedure. Based on UE capability and scheduling information, in some aspects, advanced features such as cross-component carrier (cross-CC) scheduling, BWP switching, and change of TCI state may be supported for a PUSCH transmission.

In some aspects, if the gap k is no less than the sum of the minimum time for PDSCH processing, timing advance, and PUSCH processing at the UE, and the resources indicated by the UL grant do not overlap with DL symbols and/or slots in TDD or a switching gap of half-duplex operation, the UL grant may be determined to be valid and the follow-up message 807 may be transmitted as illustrated in FIG. 8. As illustrated in relation to FIGS. 6B and 7B, a failure to decode the message 804 (and/or the UL grant included in a different message of the set of messages 802) may result in the UE refraining from transmitting the follow-up message 807. Additionally, if the resources indicated by the UL grant overlap with DL symbols and/or slots in TDD or the switching gap of half-duplex operation, the UL grant may be determined to be invalid and the follow-up message 807 (e.g., corresponding to the follow-up message 607 of FIG. 6A or the follow-up message 707 of FIG. 7A) may be omitted as illustrated in FIGS. 6B and 7B (indicated by a DTX during the PUSCH resources 657 and during the PUSCH resources 757).

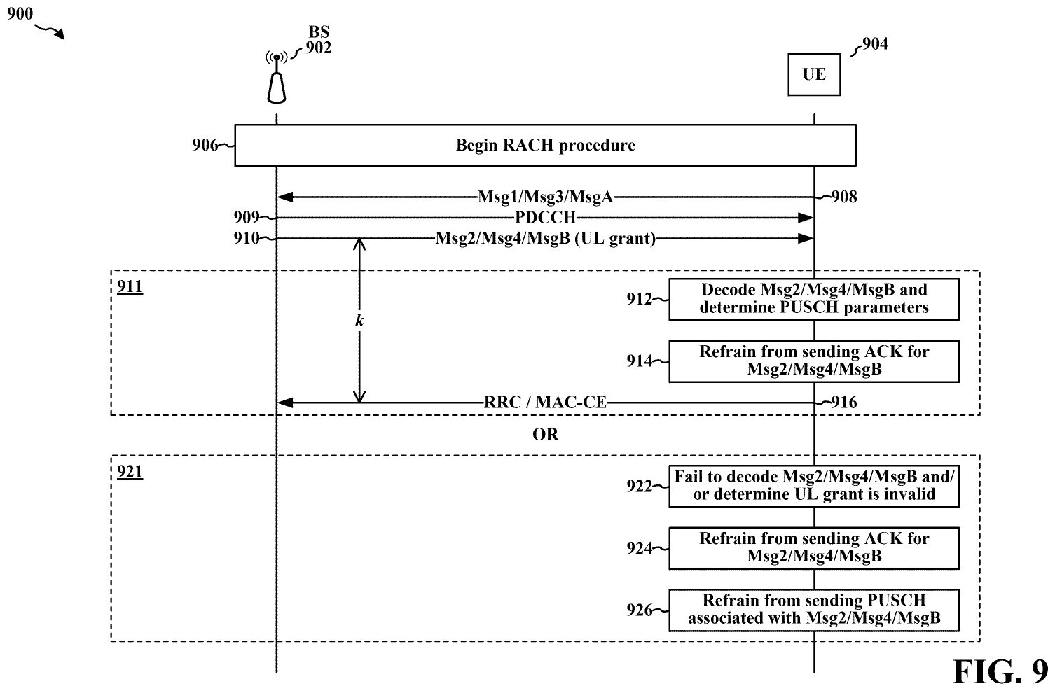

FIG. 9 is a call flow diagram 900 illustrating a method of wireless communication in accordance with some aspects of the disclosure. The method is illustrated in relation to a base station 902 (e.g., as an example of a network device or network node that may include one or more components of a disaggregated base station) in communication with a UE 904 (e.g., as an example of a wireless device). The functions ascribed to the base station 902, in some aspects, may be performed by one or more components of a network entity, a network node, or a network device (a single network entity/node/device or a disaggregated network entity/node/device as described above in relation to FIG. 1). Similarly, the functions ascribed to the UE 904, in some aspects, may be performed by one or more components of a wireless device supporting communication with a network entity/node/device. Accordingly, references to “transmitting” in the description below may be understood to refer to a first component of the base station 902 (or the UE 904) outputting (or providing) an indication of the content of the transmission to be transmitted by a different component of the base station 902 (or the UE 904). Similarly, references to “receiving” in the description below may be understood to refer to a first component of the base station 902 (or the UE 904) receiving a transmitted signal and outputting (or providing) the received signal (or information based on the received signal) to a different component of the base station 902 (or the UE 904).

At 906, the base station 902 and the UE 904 may begin a RACH procedure. In some aspects using a CBRA procedure, beginning the RACH procedure at 906 may include exchanging at least a Msg1 and Msg2. When using a CFRA procedure, beginning the RACH procedure at 906 may include transmitting an RA preamble assignment as in FIG. 4A. During the RACH procedure, the UE may transmit a message 908 (e.g., one of a Msg1 for a 4-step CFRA procedure, a Msg3 for a 4-step CBRA procedure, or a MsgA for either a CFRA or CBRA procedure). The UE 904 may monitor for and receive, and the base station 902 may transmit, PDCCH 909 scheduling a next (or final) message in the RACH procedure (e.g., one of a Msg2 for a 4-step CFRA procedure, a Msg4 for a 4-step CBRA procedure, or a MsgB for either a CFRA or CBRA procedure). In some aspects, the PDCCH 909 may include a flag indicating that the next message in the RACH procedure carries information for an UL grant (or includes an UL grant), a first DCI scheduling the next RACH message and including (e.g., issuing or scheduling) the UL grant, or a first DCI scheduling the next RACH message and a second DCI including (e.g., issuing or scheduling) the UL grant (where the PDCCH 909 may be transmitted during a single PDCCH transmission occasion including the first DCI and the second DCI or separate PDCCH transmission occasions each including one of the first DCI or the second DCI). As described above, the flag may be associated with one of a DCI field, a CRC attached to the DCI, a time and/or frequency offset of the PDCCH monitoring occasions, a DM-RS sequence of the PDCCH, or the interleaving and/or scrambling schemes associated with a DM-RS and/or PDCCH associated with the DCI.

Based on receiving the PDCCH 909, the UE 904 may monitor for and receive, and the base station 902 may transmit, the RACH message 910 (e.g., one of a Msg2 for a 4-step CFRA procedure, a Msg4 for a 4-step CBRA procedure, or a MsgB for either a CFRA or CBRA procedure). The RACH message 910 (or the PDCCH 909), in some aspects, may include the UL grant (e.g., the size of the gap k between the end (e.g., the last slot and/or symbol) of the RACH message 910 and the beginning (e.g., a first slot and/or symbol) of a related PUSCH transmission 916. In some aspects, the UE 904 may receive (e.g., in the PDCCH 909 or previous or subsequent PDCCH or in the UL grant) one or more sets of TPC parameters. For example, a first set of power control parameters may be indicated in the UL grant and a second set of power control parameters may be indicated in PDCCH (e.g., in the PDCCH 909 or previous or subsequent PDCCH). In some aspects, a TPC field in PDCCH associated with the second set of power control parameters may indicate a step size corresponding to power ramping, an update for pathloss compensation factor, or an adaptation of other power control parameters initiated by the network while a TPC field in the UL grant associated with the first set of power control parameters may indicate a relative and/or absolute value of power ramping according to the TPC field in PDCCH.

A set of operations 911, in some aspects, may be associated with a successful decoding. The set of operations 911, in some aspects may include, at 912, decoding the RACH message 910 and determining a set of parameters for a PUSCH transmission 916. The set of parameters, in some aspects, may include time and frequency resources for transmitting the PUSCH transmission 916 and power control parameters associated with the PUSCH transmission 916. The UE 904 may, as part of determining time and frequency resources for the PUSCH transmission, determine that the time and frequency resources are valid (e.g., do not overlap with DL symbols and/or slots in TDD or a switching gap of half-duplex operation). In some aspects, the UE 904 may apply the TPC field (or the first set of power control parameters) in the UL grant and the TPC field in the PDCCH may be repurposed for other control information. The UE 904, in some aspects, may apply the TPC field (or the second set of power control parameters) in PDCCH and the TPC field (or the first set of power control parameters) in the UL grant may be omitted. In some aspects, the UE 904 may apply both the second set of power control parameters and the first set of power control parameters to the PUSCH transmission 916. For example, the UE 904 may apply one or more of a step size corresponding to power ramping, an update for pathloss compensation factor, or an adaptation of other power control parameters initiated by the network included in the second set of power control parameters (e.g., in a TPC field in PDCCH) and a relative and/or absolute value of power ramping according to the TPC field in PDCCH included in the first set of power control parameters (e.g., in a TPC field in the UL grant).

The UE 904 may, at 914, refrain from transmitting an ACK related to the successful decoding of the RACH message 910 (and the associated UL grant). Refraining from transmitting the ACK at 914, in some aspects, may be based on the indication of the UL grant and/or receiving the UL grant in at least one of PDCCH 909 or RACH message 910. The UE 904 may, based on the PDCCH 909 and the RACH message 910, transmit PUSCH transmission 916. PUSCH transmission 916, in some aspects may be a RRC message (e.g., RRCReconfigurationComplete or UAI) or MAC-CE (e.g., for a BSR or a PHR) associated with the RACH procedure. The base station 902, in some aspects, may interpret receiving the PUSCH transmission as an implicit ACK. After transmitting from the UE 904, and receiving at the base station 902, the PUSCH transmission 916, the RACH process may complete.

A set of operations 921, in some aspects, may be associated with a failure to decode the RACH message 910 or the UL grant. The set of operations 921, in some aspects may include, at 922, failing to decode at least one of the RACH message 910 or the UL grant (e.g., if the UL grant is included in the first DCI or the second DCI as described in relation to PDCCH 909) or successfully decoding the RACH message 910 and the UL grant, but determining that the time and frequency resources are invalid (e.g., overlap with DL symbols and/or slots in TDD or a switching gap of half-duplex operation)

The UE 904 may, at 924, refrain from transmitting an ACK and/or NACK related to the decoding of the RACH message 910 (and the associated UL grant). Refraining from transmitting the ACK at 924, in some aspects, may be based on the indication of the UL grant and/or receiving the UL grant in at least one of PDCCH 909 or RACH message 910. The UE 904 may, based on the failure to decode at least one of the RACH message 910 or the UL grant and/or based on the determination that the time and frequency resources are invalid, omit, at 926 the transmitting a PUSCH transmission. The base station 902, in some aspects, may interpret the failure to receive the PUSCH transmission as an implicit NACK. In some aspects, after omitting the transmission of the PUSCH transmission from the UE 904 and/or failing to receive the PUSCH transmission at the base station 902 the RACH process may continue with a retransmission of RACH messages corresponding to one or more of the message 908, the PDCCH 909, and/or the RACH message 910.

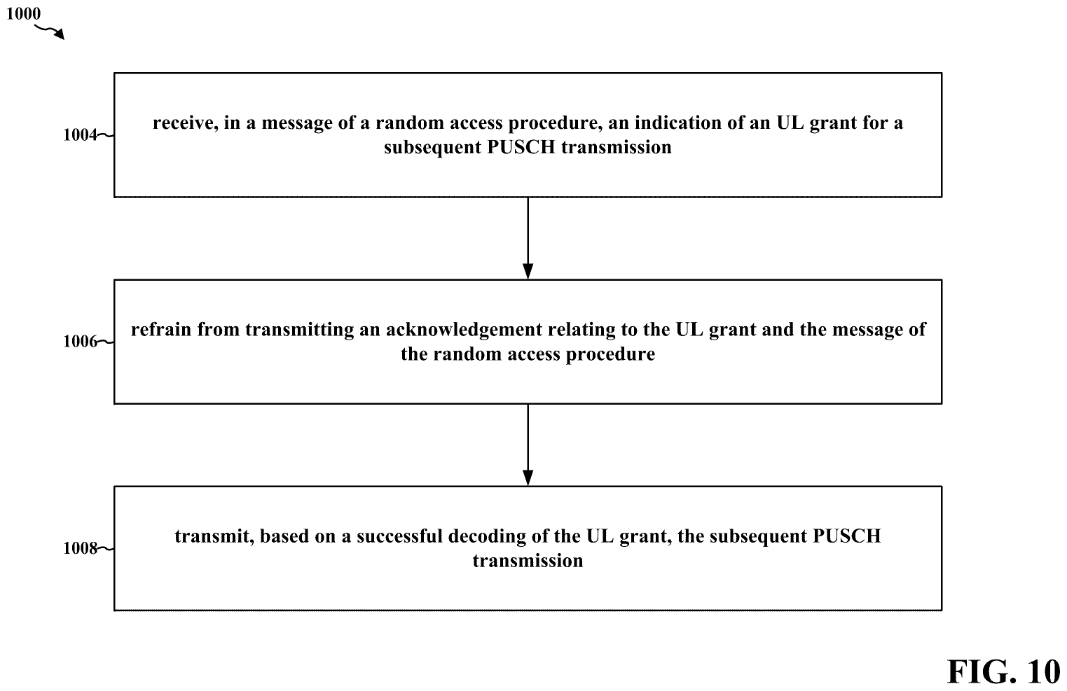

FIG. 10 is a flowchart 1000 of a method of wireless communication. The method may be performed by a UE (e.g., the UE 104, 904; the apparatus 1304). In some aspects, the UE may receive, before receiving an indication of an UL grant, an additional indication that the UL grant will be included in a message of the random access procedure. In some aspects, the additional indication that the UL grant will be included in the message of the random access procedure may be included in DCI scheduling the message of the random access procedure. The additional indication, in some aspects, may be included in a field in the DCI that, in an absence of the additional indication, is for indicating a feedback resource associated with the message of the random access procedure. In some aspects, the additional indication may be associated with at least one of a DCI field, a CRC of the DCI, a time-and-frequency offset of a PDCCH monitoring occasion, a DM-RS sequence of the PDCCH, an interleaving scheme associated with the PDCCH (or DM-RS), or a scrambling scheme associated with the PDCCH (or DM-RS). The DCI, in some aspects includes one or more fields associated with one or more of repetitions of the message of the random access procedure, a frequency hopping associated with the message of the random access procedure, and a waveform switching for the message of the random access procedure. For example, referring to FIGS. 6A, 7A, and 9, the UE 904 may receive PDCCH 909 (or PDCCH transmission 603/703) indicating that the RACH message 910 includes the UL grant.

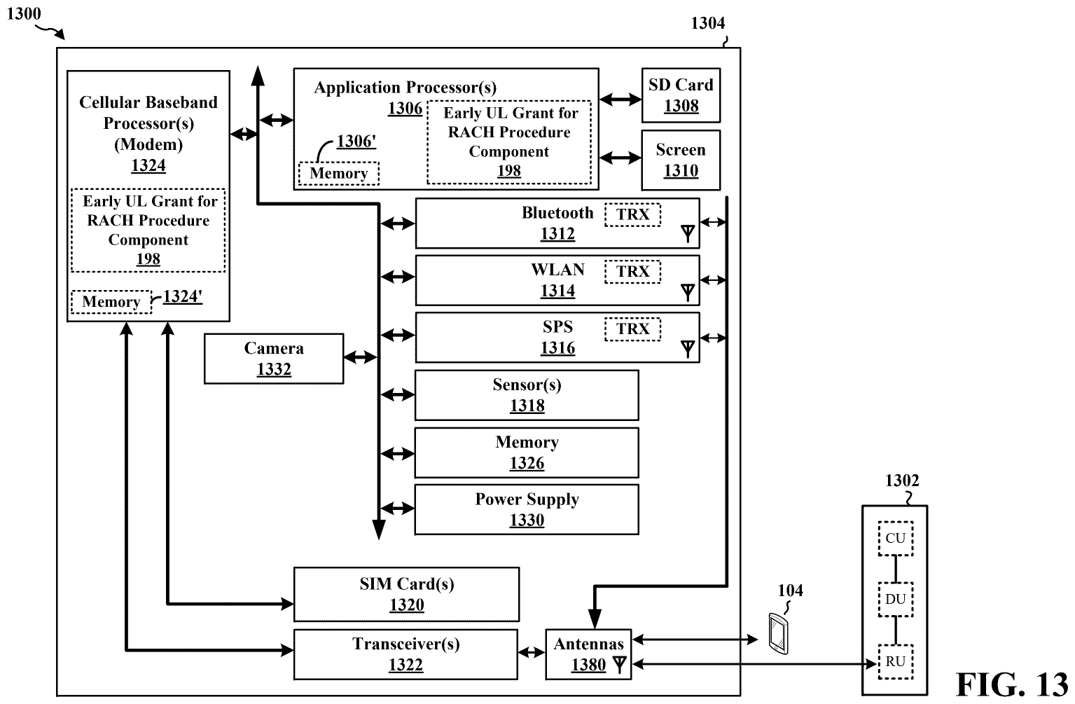

At 1004, the UE may receive, in (or in association with) the message of a random access procedure, an indication of an uplink (UL) grant for a subsequent PUSCH transmission. For example, 1004 may be performed by application processor(s) 1306, cellular baseband processor(s) 1324, transceiver(s) 1322, antenna(s) 1380, and/or early UL grant for RACH procedure component 198 of FIG. 13. In some aspects, the message of the random access procedure is one of a RAR or a contention resolution message. The message of the random access procedure, in some aspects, may include first DCI scheduling an additional message of the random access procedure and second DCI including the indication of the UL grant, where the additional message of the random access procedure may include one of a RAR or a contention resolution message. In some aspects, the first DCI and the second DCI may be included in a same PDCCH transmission occasion. The UL grant, in some aspects, may be associated with an indicated time between an end of one of a RAR or a contention resolution message associated with the UL grant and a beginning of the UL grant. For example, referring to FIGS. 6A, 7A, 8, and 9, the UE 904 may receive PDCCH 909 (or PDCCH transmission 603/703) or the RACH message 910 (or RAR 604, contention resolution message 704, or message 804) including the (indication of) the UL grant.

At 1006, the UE may refrain from transmitting an acknowledgement relating to the UL grant and the message of the random access procedure. For example, 1006 may be performed by application processor(s) 1306, cellular baseband processor(s) 1324, transceiver(s) 1322, antenna(s) 1380, and/or early UL grant for RACH procedure component 198 of FIG. 13. In some aspects, refraining from transmitting the acknowledgement at 1006 may be based on receiving the indication that an UL grant will be included in a message of the random access procedure at 1002 and/or based on receiving the indication of the UL grant (e.g., receiving an indication of parameters associated with the UL grant). For example, referring to FIGS. 6A, 7A, 8, and 9, the UE 904 may, at 914, refrain from transmitting an ACK (e.g., ACK/NACK 605, ACK/NACK 705, or ACK/NACK 805) based on the indication that the RACH message 910 (or RAR 604, contention resolution message 704, or message 804) includes a UL grant (or is associated with an UL grant included in the PDCCH 909 (or the set of messages 602/702 including the PDCCH transmission 603/703).

At 1008, the UE may transmit, based on a successful decoding of the UL grant, the subsequent PUSCH transmission. In some aspects, transmitting the subsequent PUSCH transmission at 1008 may include applying, to the subsequent PUSCH transmission, a set of power control parameters indicated in the UL grant and/or applying, to the subsequent PUSCH transmission, a set of power control parameters included in a PDCCH transmission. For example, 1008 may be performed by application processor(s) 1306, cellular baseband processor(s) 1324, transceiver(s) 1322, antenna(s) 1380, and/or early UL grant for RACH procedure component 198 of FIG. 13. In some aspects, transmitting the subsequent PUSCH transmission at 1008 may include applying a first set of power control parameters indicated in the UL grant and applying a second set of power control parameters included in the PDCCH transmission to the subsequent UL grant. In some aspects, a first power control parameter field in the PDCCH transmission indicates one or more of a step size corresponding to power ramping, an update for a pathloss compensation factor, or an adaptation of at least one other power control parameter initiated by a network and a second power control parameter field in the UL grant includes (or indicates) one of a relative value or an absolute value associated with a power ramping according to the first power control parameter field. Transmitting the subsequent PUSCH transmission, in some aspects, may further be based on a successful decoding of the additional message of the random access procedure (e.g., the RAR or contention resolution message). In some aspects, the successful decoding of the UL grant includes a successful decoding of the second DCI. The UE, in some aspects, may determine that the time (e.g., the indicated time between an end of one of a RAR or a contention resolution message associated with the UL grant and a beginning of the UL grant) is not less than a sum of a minimum time for a PDSCH processing, a TA, and a PUSCH processing and that resources indicated by the UL grant do not overlap with one of downlink resources (in TDD) or a switching gap associated with a half-duplex operation. Transmitting the subsequent PUSCH transmission, in some aspects, may further be based on the determination that the time (e.g., the indicated time between an end of one of a RAR or a contention resolution message associated with the UL grant and a beginning of the UL grant) is not less than a sum of a minimum time for a PDSCH processing, a TA, and a PUSCH processing and that resources indicated by the UL grant do not overlap with one of downlink resources (in TDD) or a switching gap associated with a half-duplex operation. For example, referring to FIGS. 6A, 7A, 8, and 9, the UE 904 may transmit PUSCH transmission 916 (e.g., follow-up message 607/707/807) based on decoding, at 912, the RACH message 910 (or RAR 604, contention resolution message 704, or message 804) and determining a set of parameters for a PUSCH transmission 916.

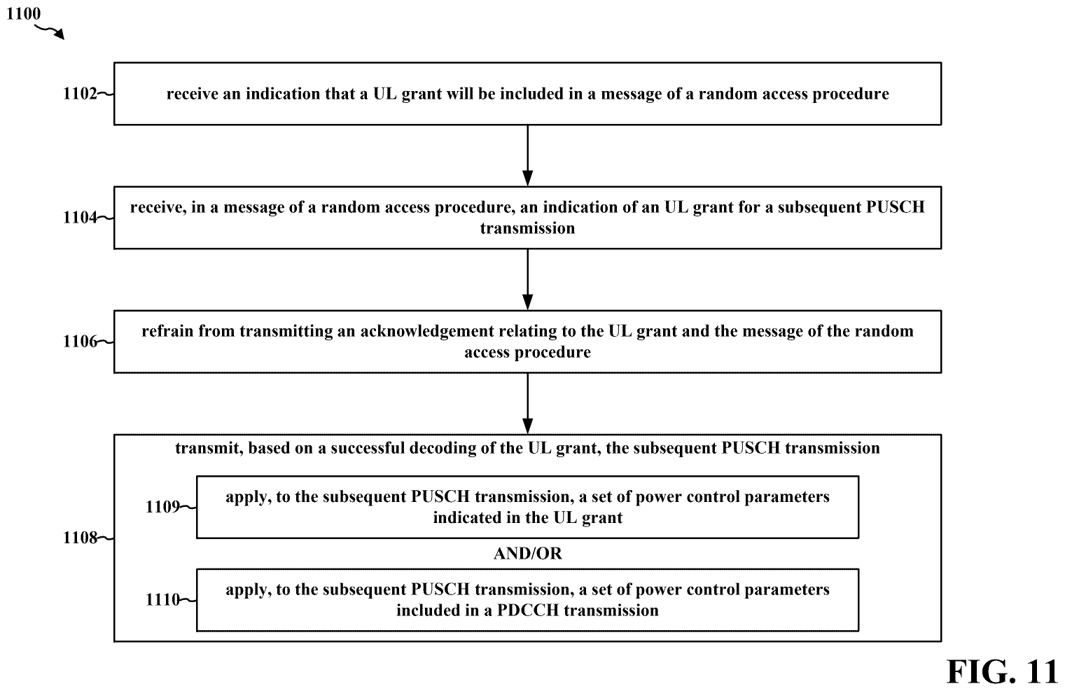

FIG. 11 is a flowchart 1100 of a method of wireless communication. The method may be performed by a UE (e.g., the UE 104, 904; the apparatus 1304). At 1102, the UE may receive, before receiving an indication of an UL grant, an additional indication that the UL grant will be included in a message of the random access procedure. For example, 1102 may be performed by application processor(s) 1306, cellular baseband processor(s) 1324, transceiver(s) 1322, antenna(s) 1380, and/or early UL grant for RACH procedure component 198 of FIG. 13. In some aspects, the additional indication that the UL grant will be included in the message of the random access procedure may be included in DCI scheduling the message of the random access procedure. The additional indication, in some aspects, may be included in a field in the DCI that, in an absence of the additional indication, is for indicating a feedback resource associated with the message of the random access procedure. In some aspects, the additional indication may be associated with at least one of a DCI field, a CRC of the DCI, a time-and-frequency offset of a PDCCH monitoring occasion, a DM-RS sequence of the PDCCH, an interleaving scheme associated with the PDCCH (or DM-RS), or a scrambling scheme associated with the PDCCH (or DM-RS). The DCI, in some aspects includes one or more fields associated with one or more of repetitions of the message of the random access procedure, a frequency hopping associated with the message of the random access procedure, and a waveform switching for the message of the random access procedure. For example, referring to FIGS. 6A, 7A, and 9, the UE 904 may receive PDCCH 909 (or PDCCH transmission 603/703) indicating that the RACH message 910 includes the UL grant.

At 1104, the UE may receive, in (or in association with) the message of a random access procedure, an indication of an uplink (UL) grant for a subsequent PUSCH transmission. For example, 1104 may be performed by application processor(s) 1306, cellular baseband processor(s) 1324, transceiver(s) 1322, antenna(s) 1380, and/or early UL grant for RACH procedure component 198 of FIG. 13. In some aspects, the message of the random access procedure is one of a RAR or a contention resolution message. The message of the random access procedure, in some aspects, may include first DCI scheduling an additional message of the random access procedure and second DCI including the indication of the UL grant, where the additional message of the random access procedure may include one of a RAR or a contention resolution message. In some aspects, the first DCI and the second DCI may be included in a same PDCCH transmission occasion. The UL grant, in some aspects, may be associated with an indicated time between an end of one of a RAR or a contention resolution message associated with the UL grant and a beginning of the UL grant. For example, referring to FIGS. 6A, 7A, 8, and 9, the UE 904 may receive PDCCH 909 (or PDCCH transmission 603/703) or the RACH message 910 (or RAR 604, contention resolution message 704, or message 804) including the (indication of) the UL grant.

At 1106, the UE may refrain from transmitting an acknowledgement relating to the UL grant and the message of the random access procedure. For example, 1106 may be performed by application processor(s) 1306, cellular baseband processor(s) 1324, transceiver(s) 1322, antenna(s) 1380, and/or early UL grant for RACH procedure component 198 of FIG. 13. In some aspects, refraining from transmitting the acknowledgement at 1106 may be based on receiving the indication that an UL grant will be included in a message of the random access procedure at 1102 and/or based on receiving the indication of the UL grant (e.g., receiving an indication of parameters associated with the UL grant). For example, referring to FIGS. 6A, 7A, 8, and 9, the UE 904 may, at 914, refrain from transmitting an ACK (e.g., ACK/NACK 605, ACK/NACK 705, or ACK/NACK 805) based on the indication that the RACH message 910 (or RAR 604, contention resolution message 704, or message 804) includes a UL grant (or is associated with an UL grant included in the PDCCH 909 (or the set of messages 602/702 including the PDCCH transmission 603/703).

At 1108, the UE may transmit, based on a successful decoding of the UL grant, the subsequent PUSCH transmission. In some aspects, transmitting the subsequent PUSCH transmission at 1108 may include, at 1109, applying, to the subsequent PUSCH transmission, a set of power control parameters indicated in the UL grant and/or, at 1110, applying, to the subsequent PUSCH transmission, a set of power control parameters included in a PDCCH transmission. For example, 1108-1110 may be performed by application processor(s) 1306, cellular baseband processor(s) 1324, transceiver(s) 1322, antenna(s) 1380, and/or early UL grant for RACH procedure component 198 of FIG. 13. In some aspects, transmitting the subsequent PUSCH transmission at 1108 may include applying a first set of power control parameters indicated in the UL grant and applying a second set of power control parameters included in the PDCCH transmission to the subsequent UL grant. In some aspects, a first power control parameter field in the PDCCH transmission indicates one or more of a step size corresponding to power ramping, an update for a pathloss compensation factor, or an adaptation of at least one other power control parameter initiated by a network and a second power control parameter field in the UL grant includes (or indicates) one of a relative value or an absolute value associated with a power ramping according to the first power control parameter field. Transmitting the subsequent PUSCH transmission, in some aspects, may further be based on a successful decoding of the additional message of the random access procedure (e.g., the RAR or contention resolution message). In some aspects, the successful decoding of the UL grant includes a successful decoding of the second DCI. Transmitting the subsequent PUSCH transmission, in some aspects, may further be based on determining that the time (e.g., the indicated time between an end of one of a RAR or a contention resolution message associated with the UL grant and a beginning of the UL grant) is not less than a sum of a minimum time for a PDSCH processing, a TA, and a PUSCH processing and that resources indicated by the UL grant do not overlap with one of downlink resources (in TDD) or a switching gap associated with a half-duplex operation. For example, referring to FIGS. 6A, 7A, 8, and 9, the UE 904 may transmit the PUSCH transmission 916 (e.g., follow-up message 607/707/807) based on decoding, at 912, the RACH message 910 (or RAR 604, contention resolution message 704, or message 804) and determining a set of parameters for the PUSCH transmission 916.

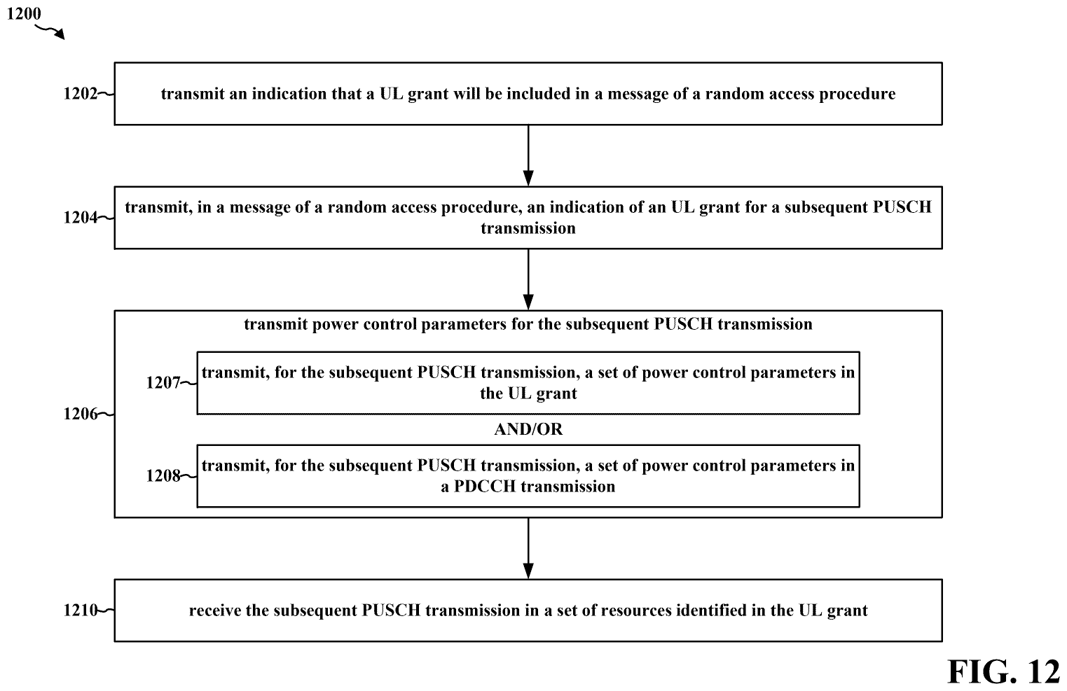

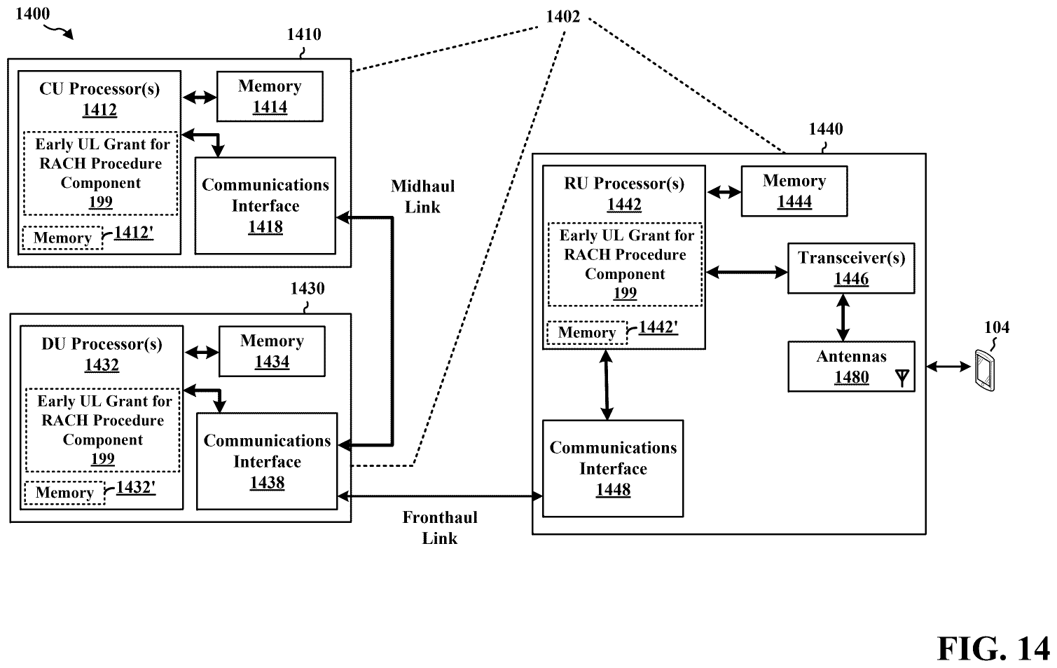

FIG. 12 is a flowchart 1200 of a method of wireless communication. The method may be performed by a base station (e.g., the base station 102, 902; the network entity 1302, 1402). At 1202, the base station may transmit, before transmitting an indication of an UL grant, an additional indication that the UL grant will be included in a message of the random access procedure. For example, 1202 may be performed by CU processor(s) 1412, DU processor(s) 1432, RU processor(s) 1442, transceiver(s) 1446, antenna(s) 1480, and/or early UL grant for RACH procedure component 199 of FIG. 14. In some aspects, the indication that the UL grant will be included in the message of the random access procedure may be included in DCI scheduling the message of the random access procedure. The indication, in some aspects, may be included in a field in the DCI that, in an absence of the additional indication, is for indicating a feedback resource associated with the message of the random access procedure. In some aspects, the indication may be associated with at least one of a DCI field, a CRC of the DCI, a time-and-frequency offset of a PDCCH monitoring occasion, a DM-RS sequence of the PDCCH, an interleaving scheme associated with the PDCCH (or DM-RS), or a scrambling scheme associated with the PDCCH (or DM-RS). The DCI, in some aspects includes one or more fields associated with one or more of repetitions of the message of the random access procedure, a frequency hopping associated with the message of the random access procedure, and a waveform switching for the message of the random access procedure. For example, referring to FIGS. 6A, 7A, and 9, the base station 902 may transmit may receive PDCCH 909 (or PDCCH transmission 603/703) indicating that the RACH message 910 includes the UL grant.

At 1204, the base station may transmit, in a message of a random access procedure, an indication of an UL grant for a subsequent PUSCH transmission. For example, 1204 may be performed by CU processor(s) 1412, DU processor(s) 1432, RU processor(s) 1442, transceiver(s) 1446, antenna(s) 1480, and/or early UL grant for RACH procedure component 199 of FIG. 14. In some aspects, the message of the random access procedure is one of a RAR or a contention resolution message. The message of the random access procedure, in some aspects, may include first DCI scheduling an additional message of the random access procedure and second DCI including the indication of the UL grant, where the additional message of the random access procedure may include one of a RAR or a contention resolution message. In some aspects, the first DCI and the second DCI may be included in a same PDCCH transmission occasion. The UL grant, in some aspects, may be associated with an indicated time between an end of one of a RAR or a contention resolution message associated with the UL grant and a beginning of the UL grant. For example, referring to FIGS. 6A, 7A, 8, and 9, the base station 902 may transmit PDCCH 909 (or PDCCH transmission 603/703) or the RACH message 910 (or RAR 604, contention resolution message 704, or message 804) including the (indication of) the UL grant.

At 1206, the base station may transmit power control parameters for the subsequent PUSCH transmission. In some aspects, transmitting the power control parameters at 1206 may include, at 1207, transmitting, in the UL grant, a set of power control parameters for the subsequent PUSCH transmission and/or, at 1208, transmitting in a PDCCH transmission, a set of power control parameters for the subsequent PUSCH transmission. For example, 1206-1208 may be performed by CU processor(s) 1412, DU processor(s) 1432, RU processor(s) 1442, transceiver(s) 1446, antenna(s) 1480, and/or early UL grant for RACH procedure component 199 of FIG. 14. In some aspects, transmitting the power control parameters at 1206 may include transmitting a first set of power control parameters in the UL grant and transmitting a second set of power control parameters in the PDCCH transmission to the subsequent UL grant. In some aspects, a first power control parameter field in the PDCCH transmission indicates one or more of a step size corresponding to power ramping, an update for a pathloss compensation factor, or an adaptation of at least one other power control parameter initiated by a network and a second power control parameter field in the UL grant includes (or indicates) one of a relative value or an absolute value associated with a power ramping according to the first power control parameter field. For example, referring to FIGS. 6A, 7A, 8, and 9, the base station 902 may transmit PDCCH 909 (or PDCCH transmission 603/703) or the RACH message 910 (or RAR 604, contention resolution message 704, or message 804) including the power control parameters.

At 1210, the base station may receive the subsequent PUSCH transmission. For example, 1210 may be performed by CU processor(s) 1412, DU processor(s) 1432, RU processor(s) 1442, transceiver(s) 1446, antenna(s) 1480, and/or early UL grant for RACH procedure component 199 of FIG. 14. In some aspects, receiving the subsequent PUSCH transmission indicates a successful decoding of both the additional message of the random access procedure (e.g., the RAR or contention resolution message) and of the UL grant included in the second DCI. For example, referring to FIGS. 6A, 7A, 8, and 9, the base station 902 may receive the PUSCH transmission 916 (e.g., follow-up message 607/707/807) based on the UE decoding, at 912, the RACH message 910 (or RAR 604, contention resolution message 704, or message 804) and determining a set of parameters for the PUSCH transmission 916.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include at least one cellular baseband processor 1324 (also referred to as a modem) coupled to one or more transceivers 1322 (e.g., cellular RF transceiver). The cellular baseband processor(s) 1324 may include at least one on-chip memory 1324′. In some aspects, the apparatus 1304 may further include one or more subscriber identity modules (SIM) cards 1320 and at least one application processor 1306 coupled to a secure digital (SD) card 1308 and a screen 1310. The application processor(s) 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize one or more antennas 1380 for communication. The cellular baseband processor(s) 1324 communicates through the transceiver(s) 1322 via the one or more antennas 1380 with the UE 104 and/or with an RU associated with a network entity 1302. The cellular baseband processor(s) 1324 and the application processor(s) 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor(s) 1324 and the application processor(s) 1306 are each responsible for general processing, including the execution of software stored on the computer-readable medium/memory. The software, when executed by the cellular baseband processor(s) 1324/application processor(s) 1306, causes the cellular baseband processor(s) 1324/application processor(s) 1306 to perform the various functions described supra. The computer-readable medium/memory may also be used for storing data that is manipulated by the cellular baseband processor(s) 1324/application processor(s) 1306 when executing software. The cellular baseband processor(s) 1324/application processor(s) 1306 may be a component of the UE 350 and may include the at least one memory 360 and/or at least one of the TX processor 368, the RX processor 356, and the controller/processor 359. In one configuration, the apparatus 1304 may be at least one processor chip (modem and/or application) and include just the cellular baseband processor(s) 1324 and/or the application processor(s) 1306, and in another configuration, the apparatus 1304 may be the entire UE (e.g., see UE 350 of FIG. 3) and include the additional modules of the apparatus 1304.

As discussed supra, the early UL grant for RACH procedure component 198 may be configured to receive, in a message of a random access procedure, an indication of an UL grant for a subsequent PUSCH transmission, refrain from transmitting an acknowledgement relating to the UL grant and the message of the random access procedure, and transmit, based on a successful decoding of the UL grant, the subsequent PUSCH transmission. The early UL grant for RACH procedure component 198 may be within the cellular baseband processor(s) 1324, the application processor(s) 1306, or both the cellular baseband processor(s) 1324 and the application processor(s) 1306. The early UL grant for RACH procedure component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1304 may include a variety of components configured for various functions. In one configuration, the apparatus 1304, and in particular the cellular baseband processor(s) 1324 and/or the application processor(s) 1306, may include means for receiving, in a message of a random access procedure, an indication of an uplink (UL) grant for a subsequent physical UL shared channel (PUSCH) transmission. The apparatus 1304, and in particular the cellular baseband processor(s) 1324 and/or the application processor(s) 1306, may include means for refraining from transmitting an acknowledgement relating to the UL grant and the message of the random access procedure. The apparatus 1304, and in particular the cellular baseband processor(s) 1324 and/or the application processor(s) 1306, may include means for transmitting, based on a successful decoding of the UL grant, the subsequent PUSCH transmission. The apparatus 1304, and in particular the cellular baseband processor(s) 1324 and/or the application processor(s) 1306, may include means for receiving, before receiving the indication of the UL grant, an additional indication that the UL grant will be included in the message of the random access procedure. The apparatus 1304, and in particular the cellular baseband processor(s) 1324 and/or the application processor(s) 1306, may include means for applying, to the subsequent PUSCH transmission, a set of power control parameters indicated in the UL grant. The apparatus 1304, and in particular the cellular baseband processor(s) 1324 and/or the application processor(s) 1306, may include means for applying a second set of power control parameters included in a physical downlink control channel (PDCCH) transmission to the subsequent UL grant, where a first power control parameter field in the PDCCH transmission indicates one or more of a step size corresponding to power ramping, an update for a pathloss compensation factor, or an adaptation of at least one other power control parameter initiated by a network and wherein a second power control parameter field in the UL grant comprises one of a relative value or an absolute value associated with a power ramping according to the first power control parameter field. The apparatus 1304, and in particular the cellular baseband processor(s) 1324 and/or the application processor(s) 1306, may include means for applying, to the subsequent PUSCH transmission, a set of power control parameters included in a physical downlink control channel (PDCCH) transmission. The apparatus 1304 may further include means for performing any of the aspects described in connection with the flowcharts in FIG. 10 or 11, and/or performed by the UE in the communication flow of FIG. 9. The means may be the early UL grant for RACH procedure component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the early UL grant for RACH procedure component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include at least one CU processor 1412. The CU processor(s) 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include at least one DU processor 1432. The DU processor(s) 1432 may include on-chip memory 1432′. In some aspects, the DU 1430 may further include additional memory modules 1434 and a communications interface 1438. The DU 1430 communicates with the RU 1440 through a fronthaul link. The RU 1440 may include at least one RU processor 1442. The RU processor(s) 1442 may include on-chip memory 1442′. In some aspects, the RU 1440 may further include additional memory modules 1444, one or more transceivers 1446, one or more antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the early UL grant for RACH procedure component 199 may be configured to transmit, in a message of a random access procedure, an indication of an UL grant for a subsequent PUSCH transmission, and receiving the subsequent PUSCH transmission in a set of resources identified in the UL grant. The early UL grant for RACH procedure component 199 may be within one or more processors of one or more of the CU 1410, DU 1430, and the RU 1440. The early UL grant for RACH procedure component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1402 may include a variety of components configured for various functions. In one configuration, the network entity 1402 may include means for transmitting, in a message of a random access procedure, an indication of an uplink (UL) grant for a subsequent physical UL shared channel (PUSCH) transmission. The network entity 1402 may include means for receiving the subsequent PUSCH transmission. The network entity 1402 may include means for transmitting, before transmitting the indication of the UL grant, an additional indication that the UL grant will be included in the message of the random access procedure. The network entity 1402 may include means for transmitting, in the UL grant, a set of power control parameters for the subsequent PUSCH transmission. The network entity 1402 may include means for transmitting, in a physical downlink control channel (PDCCH) transmission, a second set of power control parameters for the subsequent UL grant, wherein a first power control parameter field in the PDCCH transmission indicates one or more of a step size corresponding to power ramping, an update for a pathloss compensation factor, or an adaptation of at least one other power control parameter initiated by a network and where a second power control parameter field in the UL grant comprises one of a relative value or an absolute value associated with a power ramping according to the first power control parameter field. The network entity 1402 may include means for transmitting, in a physical downlink control channel (PDCCH) transmission, a set of power control parameters for the subsequent PUSCH transmission. The network entity 1402 may further include means for performing any of the aspects described in connection with the flowcharts in FIG. 12, and/or performed by the base station in the communication flow of FIG. 9. The means may be the early UL grant for RACH procedure component 199 of the network entity 1402 configured to perform the functions recited by the means. As described supra, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

Various aspects relate generally to including an UL grant in a set of transmissions associated with a RAR (or contention resolution). Some aspects more specifically relate to a DCI scheduling a RAR (or contention resolution message) also including an indication of whether the RAR includes an UL grant. If included, the UE may receive the UL grant in the RAR and refrain from transmitting an ACK/NACK. In some aspects, the DCI scheduling the RAR may also include the UL grant and/or an additional DCI including the UL grant may be included in the set of transmissions associated with the RAR (or contention resolution). In some examples, a wireless device (or UE) may be configured to receive, in a message of a random access procedure, an indication of an UL grant for a subsequent PUSCH transmission, refrain from transmitting an acknowledgement relating to the UL grant and the message of the random access procedure, and transmit, based on a successful decoding of the UL grant, the subsequent PUSCH transmission. In some examples, a network device may be configured to transmit, in a message of a random access procedure, an indication of an UL grant for a subsequent PUSCH transmission, and receiving the subsequent PUSCH transmission in a set of resources identified in the UL grant.

Particular aspects of the subject matter described in this disclosure can be implemented to realize one or more of the following potential advantages. In some examples, by including the UL grant in a set of transmissions associated with a RAR (or contention resolution) or including (in a DCI scheduling a RAR) an indication that the RAR includes an UL grant (and including the UL grant in the RAR), the described techniques can be used to improve the latency and energy efficiency of RA (e.g., CFRA and/or CBRA) procedures, resolve potential ambiguity when including the UL grant in the RAR (or an associated transmission), and provide more flexible UL scheduling for RA procedures.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: receiving, in a message of a random access procedure, an indication of an uplink (UL) grant for a subsequent physical UL shared channel (PUSCH) transmission; refraining from transmitting an acknowledgement relating to the UL grant and the message of the random access procedure; and transmitting, based on a successful decoding of the UL grant, the subsequent PUSCH transmission.

Aspect 2 is the method of aspect 1, further comprising: receiving, before receiving the indication of the UL grant, an additional indication that the UL grant will be included in the message of the random access procedure.

Aspect 3 is the method of aspect 2, wherein the additional indication that the UL grant will be included in the message of the random access procedure is included in downlink control information (DCI) scheduling the message of the random access procedure.

Aspect 4 is the method of aspect 3, wherein the additional indication is included in a field in the DCI that, in an absence of the additional indication, is for indicating a feedback resource associated with the message of the random access procedure.

Aspect 5 is the method of aspect 2, wherein the additional indication is associated with at least one of a downlink control information (DCI) field, a cyclic redundancy check of the DCI, a time-and-frequency offset of a physical downlink control channel (PDCCH) monitoring occasion, a demodulation reference signal (DMRS) sequence of the PDCCH, an interleaving scheme associated with the PDCCH, or a scrambling scheme associated with the PDCCH.

Aspect 6 is the method of any of aspects 1 to 5, wherein a DCI associated with the message of the random access procedure includes one or more fields associated with one or more of repetitions of the message of the random access procedure, a frequency hopping associated with the message of the random access procedure, and a waveform switching for the message of the random access procedure.

Aspect 7 is the method of any of aspects 1 to 6, wherein the message of the random access procedure is one of a random access response (RAR) or a contention resolution message.

Aspect 8 is the method of aspect 1, wherein the message of the random access procedure comprises first downlink control information (DCI) scheduling an additional message of the random access procedure and second DCI including the indication of the UL grant, wherein the additional message of the random access procedure comprises one of a random access response (RAR) or a contention resolution message.

Aspect 9 is the method of aspect 8, wherein the first DCI and the second DCI are included in a same PDCCH transmission occasion.

Aspect 10 is the method of any of aspects 8 and 9, wherein transmitting the subsequent PUSCH transmission is further based on a successful decoding of the additional message of the random access procedure and wherein the successful decoding of the UL grant comprises a successful decoding of the second DCI.

Aspect 11 is the method of any of aspects 1 to 10, further comprising: applying, to the subsequent PUSCH transmission, a set of power control parameters indicated in the UL grant.

Aspect 12 is the method of aspect 11, wherein the set of power control parameters is a first set of power control parameters, the method further comprising: applying a second set of power control parameters included in a physical downlink control channel (PDCCH) transmission to the subsequent PUSCH transmission, wherein a first power control parameter field in the PDCCH transmission indicates one or more of a step size corresponding to power ramping, an update for a pathloss compensation factor, or an adaptation of at least one other power control parameter initiated by a network and wherein a second power control parameter field in the UL grant comprises one of a relative value or an absolute value associated with a power ramping according to the first power control parameter field.

Aspect 13 is the method of any of aspects 1 to 10, further comprising: applying, to the subsequent PUSCH transmission, a set of power control parameters included in a physical downlink control channel (PDCCH) transmission.

Aspect 14 is the method of any of aspects 1 to 13, wherein the UL grant is associated with an indicated time between an end of one of a random access response (RAR) or a contention resolution message associated with the UL grant and a beginning of the UL grant.

Aspect 15 is the method of aspect 14, wherein transmitting the subsequent PUSCH transmission is further based on determining that the time is not less than a sum of a minimum time for a PDSCH processing, a timing advance, and a PUSCH processing and that resources indicated by the UL grant do not overlap with one of downlink resources or a switching gap associated with a half-duplex operation.

Aspect 16 is a method of wireless communication at a network device, comprising: transmitting, in a message of a random access procedure, an indication of an uplink (UL) grant for a subsequent physical UL shared channel (PUSCH) transmission; and receiving the subsequent PUSCH transmission.

Aspect 17 is the method of aspect 16, further comprising: transmitting, before transmitting the indication of the UL grant, an additional indication that the UL grant will be included in the message of the random access procedure.

Aspect 18 is the method of aspect 17, wherein the additional indication that the UL grant will be included in the message of the random access procedure is included in downlink control information (DCI) associated with the message of the random access procedure.

Aspect 19 is the method of aspect 18, wherein the additional indication is included in a repurposed field in the DCI that, in an absence of the additional indication, is for indicating a feedback resource associated with the message of the random access procedure.

Aspect 20 is the method of aspect 17, wherein the indication is associated with at least one of a downlink control information (DCI) field, a cyclic redundancy check of the DCI, a time-and-frequency offset of a physical downlink control channel (PDCCH) monitoring occasion, a demodulation reference signal (DMRS) sequence of the PDCCH, an interleaving scheme associated with the PDCCH, or a scrambling scheme associated with the PDCCH.

Aspect 21 is the method of any of aspects 16 to 20, wherein a DCI associated with the message of the random access procedure includes one or more fields associated with one or more of repetitions of the message of the random access procedure, a frequency hopping associated with the message of the random access procedure, and a waveform switching for the message of the random access procedure.

Aspect 22 is the method of any of aspects 16 to 21, wherein the message of the random access procedure is one of a random access response (RAR) or a contention resolution message.

Aspect 23 is the method of aspect 16, wherein the message of the random access procedure comprises first downlink control information (DCI) scheduling an additional message of the random access procedure and second DCI including the indication of the UL grant, wherein the additional message of the random access procedure comprises one of a random access response (RAR) or a contention resolution message.

Aspect 24 is the method of aspect 23, wherein the first DCI and the second DCI are included in a same PDCCH transmission occasion.

Aspect 25 is the method of any of aspects 23 and 24, wherein receiving the subsequent PUSCH transmission indicates a successful decoding of both the additional message of the random access procedure and of the UL grant included in the second DCI.

Aspect 26 is the method of any of aspects 16 to 25, further comprising: transmitting, in the UL grant, a set of power control parameters for the subsequent PUSCH transmission.

Aspect 27 is the method of aspect 26, wherein the set of power control parameters is a first set of power control parameters, the method further comprising: transmitting, in a physical downlink control channel (PDCCH) transmission, a second set of power control parameters for the subsequent PUSCH transmission, wherein a first power control parameter field in the PDCCH transmission indicates one or more of a step size corresponding to power ramping, an update for a pathloss compensation factor, or an adaptation of at least one other power control parameter initiated by a network and wherein a second power control parameter field in the UL grant comprises one of a relative value or an absolute value associated with a power ramping according to the first power control parameter field.

Aspect 28 is the method of any of aspects 16 to 25, further comprising: transmitting, in a physical downlink control channel (PDCCH) transmission, a set of power control parameters for the subsequent PUSCH transmission.

Aspect 29 is the method of any of aspects 16 to 28, wherein the UL grant is associated with an indicated time between an end of one of a random access response (RAR) or a contention resolution message associated with the UL grant and a beginning of the UL grant.

Aspect 30 is an apparatus for wireless communication at a device including a memory and at least one processor coupled to the memory and, based at least in part on information stored in the memory, the at least one processor is configured to implement any of aspects 1 to 15.

Aspect 31 is the apparatus of aspect 30, further including a transceiver or an antenna coupled to the at least one processor.

Aspect 32 is an apparatus for wireless communication at a device including means for implementing any of aspects 1 to 15.

Aspect 33 is a computer-readable medium (e.g., a non-transitory computer-readable medium) storing computer executable code, where the code when executed by a processor causes the processor to implement any of aspects 1 to 15.

Aspect 34 is an apparatus for wireless communication at a device including a memory and at least one processor coupled to the memory and, based at least in part on information stored in the memory, the at least one processor is configured to implement any of aspects 16 to 29.

Aspect 35 is the apparatus of aspect 34, further including a transceiver or an antenna coupled to the at least one processor.

Aspect 36 is an apparatus for wireless communication at a device including means for implementing any of aspects 16 to 29.

Aspect 37 is a computer-readable medium (e.g., a non-transitory computer-readable medium) storing computer executable code, where the code when executed by a processor causes the processor to implement any of aspects 16 to 29.

What is claimed is:

1. An apparatus for wireless communication at a user equipment (UE), comprising:
at least one memory; and
at least one processor coupled to the at least one memory and, based at least in part on stored information that is stored in the at least one memory, the at least one processor, individually or in any combination, is configured to:
receive, in a message of a random access procedure, an indication of an uplink (UL) grant for a subsequent physical UL shared channel (PUSCH) transmission;
refrain from transmitting an acknowledgement relating to the UL grant and the message of the random access procedure; and
transmit, based on a successful decoding of the UL grant, the subsequent PUSCH transmission.

2. The apparatus of claim 1, further comprising a transceiver coupled to the at least one processor, wherein the at least one processor, individually or in any combination, is further configured to:
receive, via the transceiver and before receiving the indication of the UL grant, an additional indication that the UL grant will be included in the message of the random access procedure.

3. The apparatus of claim 2, wherein the additional indication that the UL grant will be included in the message of the random access procedure is included in downlink control information (DCI) scheduling the message of the random access procedure.

4. The apparatus of claim 3, wherein the additional indication is included in a field in the DCI that, in an absence of the additional indication, is for indicating a feedback resource associated with the message of the random access procedure.

5. The apparatus of claim 2, wherein the additional indication is associated with at least one of a downlink control information (DCI) field, a cyclic redundancy check of the DCI, a time-and-frequency offset of a physical downlink control channel (PDCCH) monitoring occasion, a demodulation reference signal (DMRS) sequence of the PDCCH, an interleaving scheme associated with the PDCCH, or a scrambling scheme associated with the PDCCH.

6. The apparatus of claim 1, wherein a DCI associated with the message of the random access procedure includes one or more fields associated with one or more of repetitions of the message of the random access procedure, a frequency hopping associated with the message of the random access procedure, and a waveform switching for the message of the random access procedure.

7. The apparatus of claim 1, wherein the message of the random access procedure is one of a random access response (RAR) or a contention resolution message.

8. The apparatus of claim 1, wherein the message of the random access procedure comprises first downlink control information (DCI) scheduling an additional message of the random access procedure and second DCI including the indication of the UL grant, wherein the additional message of the random access procedure comprises one of a random access response (RAR) or a contention resolution message.

9. The apparatus of claim 8, wherein the first DCI and the second DCI are included in a same PDCCH transmission occasion.

10. The apparatus of claim 8, wherein, to transmit the subsequent PUSCH transmission, the at least one processor, individually or in any combination, is further configured to transmit the subsequent PUSCH transmission based on a successful decoding of the additional message of the random access procedure, wherein the successful decoding of the UL grant comprises a successful decoding of the second DCI.

11. The apparatus of claim 1, wherein the at least one processor, individually or in any combination, is further configured to:
apply, to the subsequent PUSCH transmission, a set of power control parameters indicated in the UL grant.

12. The apparatus of claim 11, wherein the set of power control parameters is a first set of power control parameters, and wherein the at least one processor, individually or in any combination, is further configured to:
apply a second set of power control parameters included in a physical downlink control channel (PDCCH) transmission to the subsequent PUSCH transmission, wherein a first power control parameter field in the PDCCH transmission indicates one or more of a step size corresponding to power ramping, an update for a pathloss compensation factor, or an adaptation of at least one other power control parameter initiated by a network and wherein a second power control parameter field in the UL grant comprises one of a relative value or an absolute value associated with the power ramping according to the first power control parameter field.

13. The apparatus of claim 1, wherein the at least one processor, individually or in any combination, is further configured to:
apply, to the subsequent PUSCH transmission, a set of power control parameters included in a physical downlink control channel (PDCCH) transmission.

14. The apparatus of claim 1, wherein the UL grant is associated with an indicated time between an end of one of a random access response (RAR) or a contention resolution message associated with the UL grant and a beginning of the UL grant.

15. The apparatus of claim 14, wherein, to transmit the subsequent PUSCH transmission, the at least one processor, individually or in any combination, is further configured to transmit the subsequent PUSCH transmission based on a determination that the time is not less than a sum of a minimum time for a PDSCH processing, a timing advance, and a PUSCH processing and that resources indicated by the UL grant do not overlap with one of downlink resources or a switching gap associated with a half-duplex operation.

16. A method of wireless communication at a user equipment (UE), comprising:
receiving, in a message of a random access procedure, an indication of an uplink (UL) grant for a subsequent physical UL shared channel (PUSCH) transmission;
refraining from transmitting an acknowledgement relating to the UL grant and the message of the random access procedure; and
transmitting, based on a successful decoding of the UL grant, the subsequent PUSCH transmission.

17. The method of claim 16, further comprising:
receiving, before receiving the indication of the UL grant, an additional indication that the UL grant will be included in the message of the random access procedure, wherein the message of the random access procedure is one of a random access response (RAR) or a contention resolution message.

18. The method of claim 17, wherein the additional indication that the UL grant will be included in the message of the random access procedure is included in downlink control information (DCI) scheduling the message of the random access procedure.

19. The method of claim 17, wherein the additional indication is associated with at least one of a downlink control information (DCI) field, a cyclic redundancy check of the DCI, a time-and-frequency offset of a physical downlink control channel (PDCCH) monitoring occasion, a demodulation reference signal (DMRS) sequence of the PDCCH, an interleaving scheme associated with the PDCCH, or a scrambling scheme associated with the PDCCH.

20. An apparatus for wireless communication at a user equipment (UE), comprising:
means for receiving, in a message of a random access procedure, an indication of an uplink (UL) grant for a subsequent physical UL shared channel (PUSCH) transmission;
means for refraining from transmitting an acknowledgement relating to the UL grant and the message of the random access procedure; and
means for transmitting, based on a successful decoding of the UL grant, the subsequent PUSCH transmission.
